(19) United States
(12) Patent Application Publication
(10) Pub. No.: US 2022/0342424 A1
(43) Pub. Date: Oct. 27, 2022

(54) DETECTING DEVICE AND ROBOT DUST COLLECTOR

(71) Applicant: MAKITA CORPORATION, Anjo-shi, Aichi (JP)

(72) Inventor: Yudai SUGINO, Anjo-shi (JP)

(73) Assignee: MAKITA CORPORATION, Anjo-shi, Aichi (JP)

(21) Appl. No.: 17/763,436

(22) PCT Filed: Jun. 24, 2020
(86) PCT No.: PCT/JP2020/024914

§ 371 Date: Mar. 24, 2022

(30) Foreign Application Priority Data
Oct. 30, 2019 (JP) 2019-197346

(51) Int. Cl. G05D 1/02; G01S 7/481; A47L 9/28; A47L 9/00

(52) U.S. Cl. CPC G05D 1/0238; G01S 7/4813; A47L 9/2884; A47L 9/2805; A47L 9/2852; A47L 9/009; G05D 2201/0215; A47L 2201/04

(57) ABSTRACT

A detecting device including an optical sensor includes: a cover member that is arranged at least partially around the optical sensor and is rotatable about a first rotation axis; and a rotation sensor configured to detect rotation of the cover member.

### FIELD

The present disclosure relates to a detecting device and a robot dust collector.

### BACKGROUND

In the technical field pertaining to robot dust collectors, a robot dust collector as disclosed in Patent Literature 1 is known.

### CITATION LIST

### Patent Literature

Patent Literature 1: German Patent Application Publication No. 102013106294

### SUMMARY

### Technical Problem

In a robot dust collector including a detecting device that detects objects in the vicinity, the detecting device may come into contact with objects when the robot dust collector is traveling. Repeated contact between the detecting device and objects may deteriorate the detecting device.

An object of the present disclosure is to detect contact between a detecting device and an object.

### Solution to Problem

According to the present disclosure, there is provided a detecting device including an optical sensor. The detecting device includes: a cover member that is arranged at least partially around the optical sensor and is rotatable about a first rotation axis; and a rotation sensor configured to detect rotation of the cover member.

### Advantageous Effects of Invention

According to the present disclosure, contact between a detecting device and an object can be detected.

### BRIEF DESCRIPTION OF DRAWINGS

FIG. 1 is a perspective view of a robot dust collector according to an embodiment.

FIG. 2 is a top view of the robot dust collector according to the embodiment.

FIG. 3 is a bottom view of the robot dust collector according to the embodiment.

FIG. 4 is a side view of the robot dust collector according to the embodiment.

FIG. 5 is a block diagram of the robot dust collector according to the embodiment.

FIG. 6 is a perspective view of a detecting device according to the embodiment.

FIG. 7 is a perspective view of a part of the detecting device according to the embodiment.

FIG. 8 is a perspective view of an optical sensor according to the embodiment.

FIG. 9 is a sectional view of the optical sensor according to the embodiment.

FIG. 10 is a perspective view of the detecting device according to the embodiment.

FIG. 11 is a sectional view of the detecting device according to the embodiment.

FIG. 12 is a perspective view of a part of the detecting device according to the embodiment.

FIG. 13 is a plan view of the detecting device according to the embodiment.

FIG. 14 is a perspective bottom view of a part of the detecting device according to the embodiment.

FIG. 15 is a plan view of a part of the detecting device according to the embodiment.

FIG. 16 is a plan view of a cover member according to the embodiment.

FIG. 17 is a view illustrating an operation of the robot dust collector according to the embodiment.

FIG. 18 is a view illustrating an operation of the robot dust collector according to the embodiment.

### DESCRIPTION OF EMBODIMENTS

An embodiment of the present disclosure will described below with reference to the drawings. However, the present disclosure is not limited to the embodiment. The components of the embodiment described below can be combined as appropriate. Some of the components may not be used.

In the embodiment, positional relations between components will be described using the terms “left”, “right”, “front (ahead)”, “rear (behind)”, “up (top)”, and “down (bottom)”. These terms refer to relative positions or directions with respect to the center of a robot dust collector 1.

Robot Dust Collector

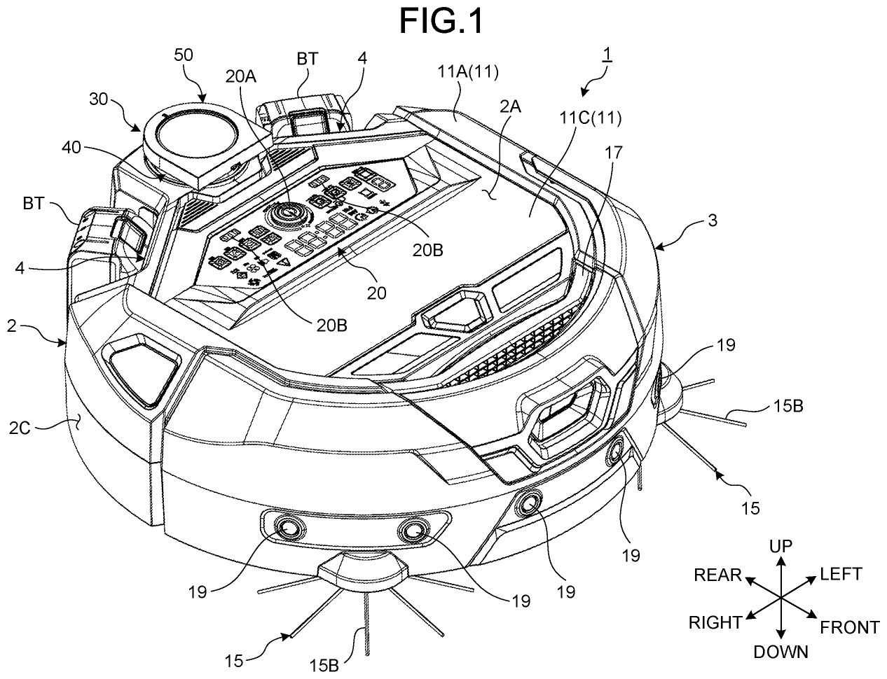

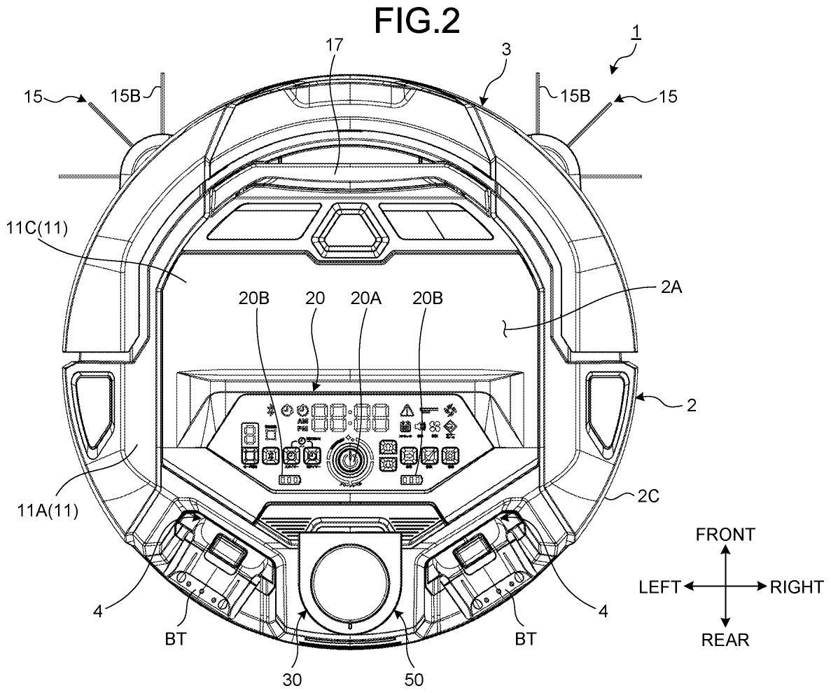

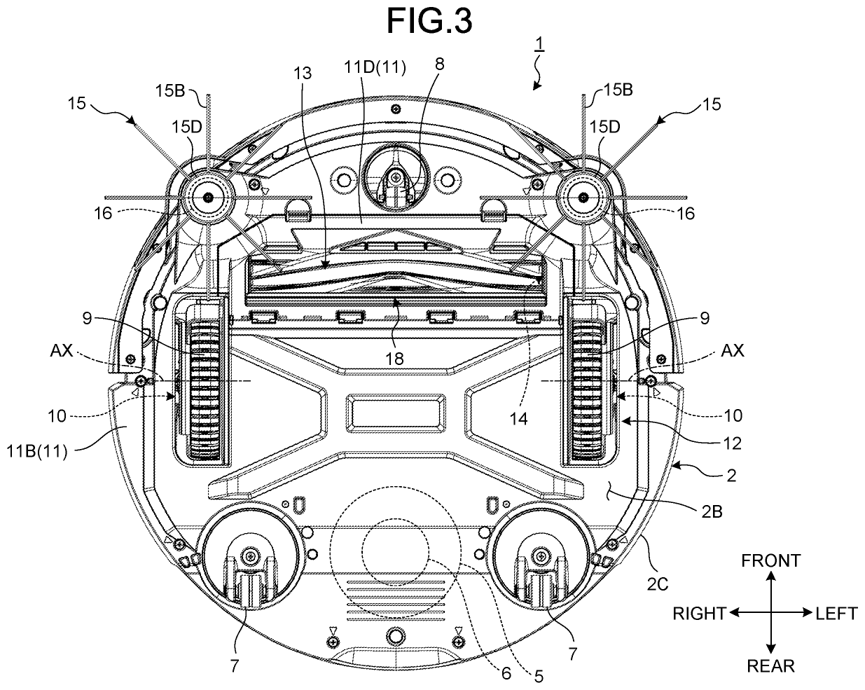

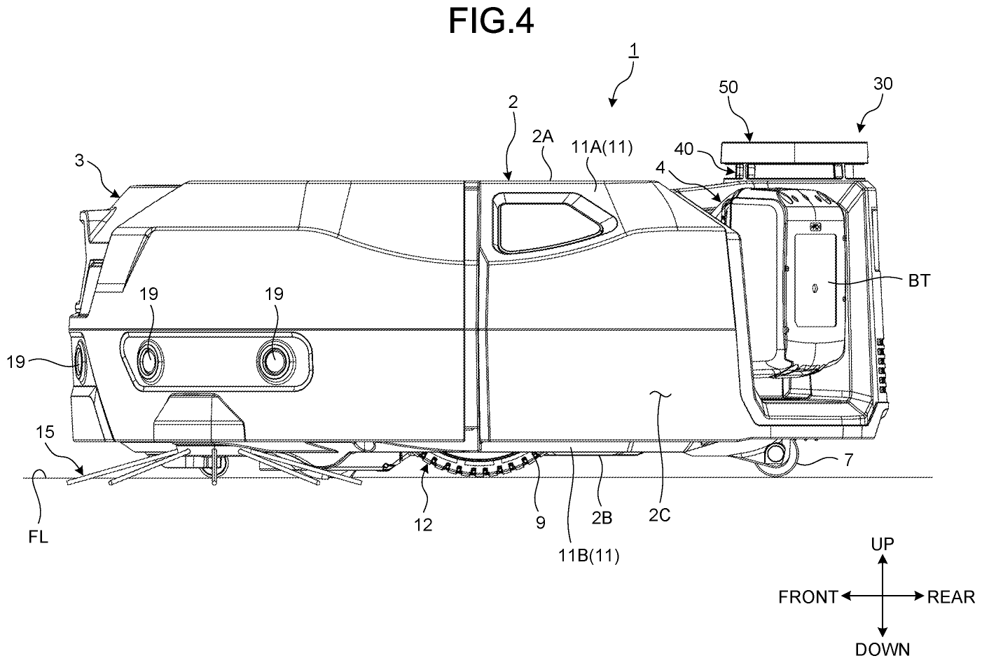

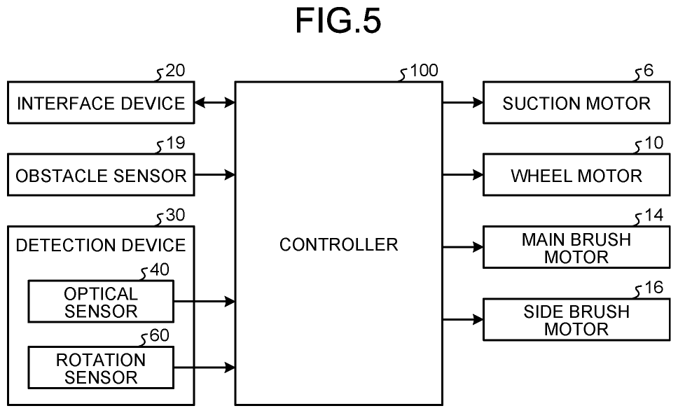

FIG. 1 is a perspective view of the robot dust collector 1 according to the embodiment. FIG. 2 is a top view of the robot dust collector 1 according to the embodiment. FIG. 3 is a bottom view of the robot dust collector 1 according to the embodiment. FIG. 4 is a side view of the robot dust collector 1 according to the embodiment. FIG. 5 is a block diagram of the robot dust collector 1 according to the embodiment.

In the embodiment, positional relations between components are described using the terms “left”, “right”, “front (ahead)”, “rear (behind)”, “up (top)”, and “down (bottom)”. These terms refer to relative positions or directions with respect to the center of the robot dust collector 1.

The robot dust collector 1 collects dust while autonomously traveling on a cleaning target floor FL. As illustrated in FIG. 1, FIG. 2, FIG. 3, FIG. 4, and FIG. 5, the robot dust collector 1 includes a body 2, a bumper 3, battery mounting parts 4, a suction fan 5, a suction motor 6, casters 7, a roller 8, a traveling device 12, a main brush 13, a main brush motor 14, side brushes 15, side brush motors 16, a handle 17, obstacle sensors 19, an interface device 20, a detecting device 30, and a controller 100.

The body 2 has a top face 2A, a bottom face 2B facing the cleaning target floor FL, and a side face 2C that connects an edge of the top face 2A and an edge of the bottom face 2B. In a plane parallel to the top face 2A, the body 2 has a substantially circular shape.

The body 2 includes a housing 11 having an internal space. The housing 11 includes: an upper housing 11A; a lower housing 11B arranged below the upper housing 11A and connected to the upper housing 11A; a cover plate 11C mounted on the upper housing 11A so as to be openable and closable; and a bottom plate 11D attached to the lower housing 11B. The top face 2A is arranged on the upper housing 11A and the cover plate 11C. The bottom face 2B is arranged in the lower housing 11B and the bottom plate 11D.

The housing 11 has a suction inlet 18 in the bottom face 2B. The suction inlet 18 is provided in the bottom plate 11D. The suction inlet 18 is provided in a front portion of the bottom face 2B. The suction inlet 18 faces the cleaning target floor FL. The suction inlet 18 sucks dust and dirt on the cleaning target floor FL.

The bumper 3 can be moved while facing at least a part of the side face 2C. The bumper 3 is movably supported by the body 2. The bumper 3 faces a front portion of the side face 2C. Upon colliding with an object present around the robot dust collector 1, the bumper 3 moves relative to the body 2, thereby absorbing an impact that acts on the body 2.

The battery mounting parts 4 support batteries BT. The batteries BT are mounted on the battery mounting parts 4. The battery mounting parts 4 are provided on at least parts of the outer surface of the body 2. Recesses are provided in a rear portion of the upper housing 11A. The battery mounting parts 4 are provided inside the respective recesses in the upper housing 11A. Two such battery mounting parts 4 in total are provided.

The batteries BT mounted on the battery mounting parts 4 supply electric power to an electric or electronic device mounted on the robot dust collector 1. The battery BT is a general-purpose battery that can be used as a power source for various electric devices. The battery BT can be used as a power source for power tools. The battery BT can be used as a power source for an electric device other than power tools. The battery BT can be used as a power source for a dust collector other than the robot dust collector 1 according to the embodiment. Examples of the battery BT include a lithium-ion battery. The battery BT is a rechargeable battery that can be recharged. The battery mounting part 4 has the same structure as a battery mounting part of a power tool.

The suction fan 5 rotates to generate, at the suction inlet 18, suction force for sucking dust and dirt. The suction fan 5 is arranged in the internal space of the housing 11.

The suction motor 6 generates motive power to rotate the suction fan 5. The suction motor 6 is arranged in the internal space of the housing 11.

The body 2 is movably supported by the casters 7 and the roller 8. The casters 7 and the roller 8 are individually rotatably supported by the body 2. Two such casters 7 in total are provided in a rear portion of the bottom face 2B. One of the casters 7 is provided in a left portion of the body 2. The other caster 7 is provided in a right portion of the body 2. One such roller 8 in total is provided in the front portion of the bottom face 2B.

The traveling device 12 moves the body 2 in at least one of the frontward and rearward directions. The traveling device 12 includes wheels 9 and wheel motors 10.

The body 2 is movably supported by the wheels 9. The individual wheels 9 rotate about a rotation axis AX extending in the left-right direction. At least a part of each of the wheels 9 projects downward from the bottom face 2B. With the wheels 9 placed on the cleaning target floor FL, the bottom face 2B of the body 2 faces the cleaning target floor FL with a gap therebetween. Two such wheels 9 in total are provided. One of the wheels 9 is provided in the left portion of the body 2. The other wheel 9 is provided in the right portion of the body 2.

The wheel motors 10 generate motive power to rotate the wheels 9. The wheel motors 10 are driven by electric power supplied from the batteries BT. The wheel motors 10 are arranged in the internal space of the housing 11. Two such wheel motors 10 in total are provided. One of the wheel motors 10 generates motive power to rotate the wheel 9 provided in the left portion of the body 2. The other wheel motor 10 generates motive power to rotate the wheel 9 provided in the right portion of the body 2. When the wheels 9 rotate, the robot dust collector 1 autonomously travels.

The main brush 13 is arranged in the suction inlet 18. The main brush 13 faces the cleaning target floor FL. The main brush 13 rotates about a rotation axis extending in the left-right direction. The main brush 13 is movably supported by the body 2. The main brush 13 is supported by the body 2 in such a manner that at least a part of the main brush 13 projects downward from the bottom face 2B. With the wheels 9 placed on the cleaning target floor FL, at least a part of the main brush 13 makes contact with the cleaning target floor FL.

The main brush motor 14 generates motive power to rotate the main brush 13. The main brush motor 14 is driven by electric power supplied from the batteries BT. The main brush motor 14 is arranged in the internal space of the housing 11. When the main brush motor 14 is driven, the main brush 13 rotates. When the main brush 13 rotates, dust and dirt present on the cleaning target floor FL are gathered up and sucked in through the suction inlet 18.

The side brushes 15 are arranged in the front portion of the bottom face 2B. The side brushes 15 face the cleaning target floor FL. At least a part of the side brush 15 is arranged ahead of the body 2. Two such side brushes 15 in total are provided. One of the side brushes 15 is provided to the left of the suction inlet 18. The other side brush 15 is provided to the right of the suction inlet 18. The side brush 15 includes a disc member 15D and a plurality of brushes 15B radially connected to the disc member 15D. The disc member 15D is rotatably supported by the body 2. The disc member 15D is supported by the body 2 in such a manner that at least a part of the brushes 15B projects outside of the side face 2C. With the wheels 9 placed on the cleaning target floor FL, at least a part of the side brushes 15 makes contact with the cleaning target floor FL.

The side brush motors 16 generate motive power to rotate the side brushes 15. The side brush motors 16 are driven by electric power supplied from the batteries BT. The side brush motors 16 are arranged in the internal space of the housing 11. When the side brush motors 16 are driven, the side brushes 15 rotate. When the side brushes 15 rotate, dust and dirt present on the cleaning target floor FL in an area surrounding the body 2 move to the suction inlet 18.

The handle 17 is provided in a front portion of the upper housing 11A. One end and the other end of the handle 17 are turnably coupled to the upper housing 11A. The user of the robot dust collector 1 can lift the robot dust collector 1 by gripping the handle 17. The user of the robot dust collector 1 can carry the robot dust collector 1.

The interface device 20 is arranged in a rear portion of the cover plate 11C. The interface device 20 includes a plurality of operation parts and a plurality of indicators that are to be operated by the user of the robot dust collector 1. A power button 20A is exemplified as one of the operation parts of the interface device 20. Remaining power indicators 20B for the batteries BT are exemplified as the indicators of the interface device 20.

The obstacle sensor 19 detects, in a non-contact manner, an object present on at least a part of an area surrounding the robot dust collector 1. The obstacle sensor 19 includes an ultrasonic sensor that detects objects by emitting ultrasonic waves. A plurality of such obstacle sensors 19 in total are provided at intervals on the side face 2C of the body 2. Based on detection data from the obstacle sensors 19, the controller 100 controls the wheel motors 10 to change the traveling direction of the traveling device 12 or stop traveling thereof so that the body 2 or the bumper 3 can avoid making contact with the object. The controller 100 may change the traveling direction of the traveling device 12 or stop traveling thereof after the body 2 or the bumper 3 makes contact with the objects.

Detecting Device

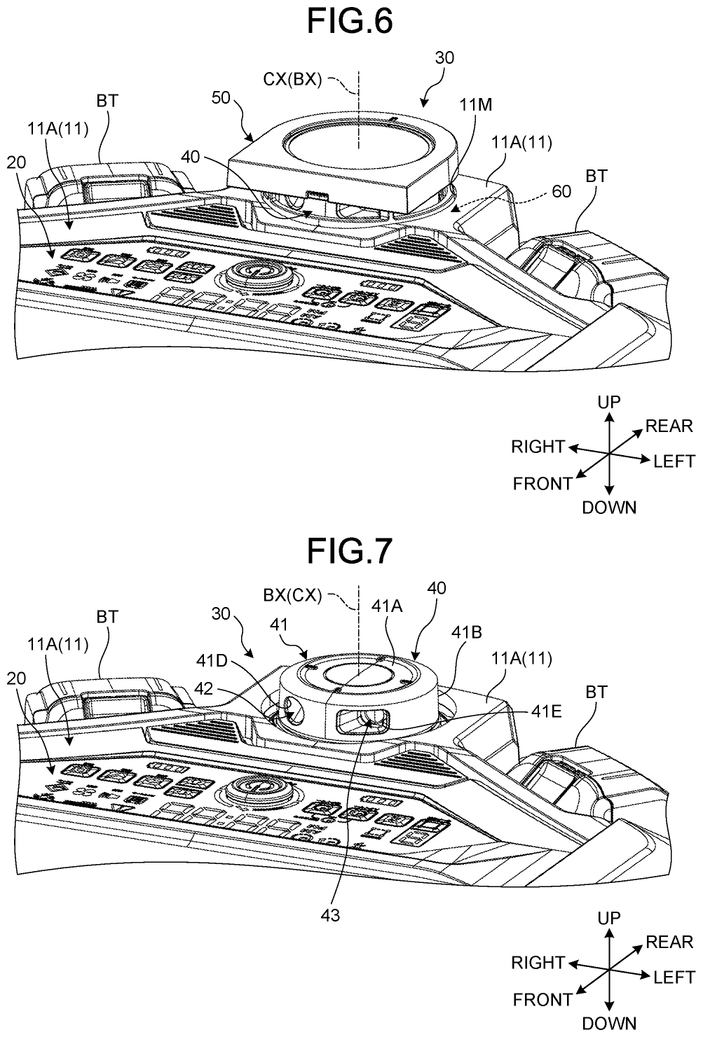

FIG. 6 is a perspective view of the detecting device 30 according to the embodiment. As illustrated in FIG. 1, FIG. 2, FIG. 4, and FIG. 6, the detecting device 30 is supported by the upper housing 11A. The detecting device 30 is arranged in the rear portion of the upper housing 11A.

The detecting device 30 includes an optical sensor 40, a cover member 50 arranged at least partially around the optical sensor 40 and rotatable around a rotation axis CX, and a rotation sensor 60 that detects rotation of the cover member 50.

The optical sensor 40 emits detection light to detect objects around the body 2 in a non-contact manner. In the embodiment, the optical sensor 40 includes a laser sensor (LIDAR: light detection and ranging) that detects objects by emitting a laser beam. The optical sensor 40 may include an infrared sensor that detects objects by emitting infrared light or a radar sensor (RADAR: radio detection and ranging) that detects objects by emitting radio waves.

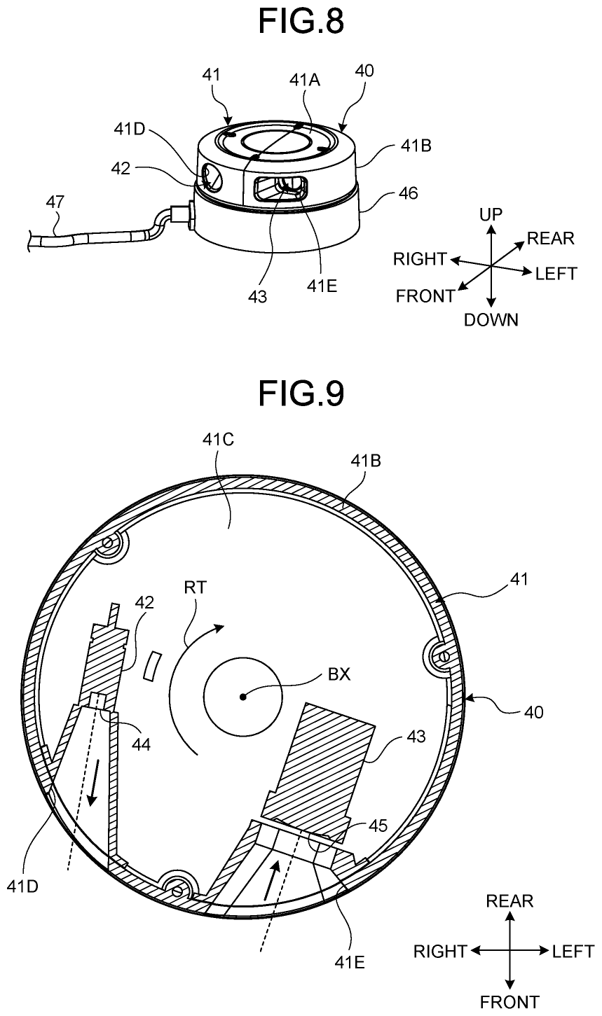

FIG. 7 is a perspective view of a part of the detecting device 30 according to the embodiment. FIG. 7 corresponds to the view of FIG. 6 but with the cover member 50 removed. FIG. 8 is a perspective view of the optical sensor 40 according to the embodiment. FIG. 9 is a sectional view of the optical sensor 40 according to the embodiment.

As illustrated in FIG. 7, FIG. 8, and FIG. 9, the optical sensor 40 includes a rotating body 41 that rotates about a rotation axis BX, a light emitter 42 provided in the rotating body 41, a light receiver 43 provided in the rotating body 41, and a support member 46 supporting the rotating body 41 in such a manner that allows the rotating body 41 to rotate.

The rotating body 41 includes a top plate part 41A, a side plate part 41B, and a holding plate part 41C. The top plate part 41A, the side plate part 41B, and the holding plate part 41C define an internal space of the rotating body 41. The light emitter 42 and the light receiver 43 are individually arranged in the internal space of the rotating body 41. The top plate part 41A is arranged above the light emitter 42 and the light receiver 43. The side plate part 41B is arranged around the light emitter 42 and the light receiver 43. The side plate part 41B has a first opening 41D through which the detection light emitted from the light emitter 42 passes, and a second opening 41E through which the detection light entering the light receiver 43 passes. The holding plate part 41C is arranged below the top plate part 41A and the side plate part 41B. The light emitter 42 and light receiver 43 are held by the holding plate part 41C.

The rotating body 41 rotates with the light emitter 42 and the light receiver 43 held therein. The rotation axis BX of the rotating body 41 is perpendicular to the top face 2A of the body 2. The rotation axis BX extends in the up-down direction. In a cross section perpendicular to the rotation axis BX, the rotating body 41 has a circular shape. In the embodiment, the rotating body 41 rotates in a rotation direction indicated by the arrow RT in FIG. 9.

The light emitter 42 is held in the rotating body 41. The light emitter 42 emits detection light. The light emitter 42 emits a laser beam as the detection light. The light emitter 42 has a light emitting surface 44 from which the detection light is emitted. The detection light emitted from the light emitting surface 44 passes through openings in the cover member 50 and irradiates objects around the body 2. As described later, the cover member 50 includes a plurality of leg parts 52. The openings in the cover member 50 are defined between the adjacent leg parts 52.

The light receiver 43 is held in the rotating body 41. The light receiver 43 receives at least a part of the detection light emitted from the light emitter 42. The light receiver 43 has a light receiving surface 45 that the detection light enters. At least a part of the detection light emitted from the light emitter 42 and radiated to an object is reflected by the object. The detection light reflected by the object passes through the openings provided in the cover member 50 and enters the light receiving surface 45. Based on the detection light received by the light receiver 43, the controller 100 detects whether an object exists around the body 2. Based on the detection light received by the light receiver 43, the light receiver 43 detects the distance to the object.

The light emitting surface 44 and light receiving surface 45 are arranged above the top face 2A of the body 2 (the housing 11). The detection light emitted forward from the light emitting surface 44 passes through a space above the top face 2A of the body 2 and irradiates objects ahead of the body 2. When an object ahead of the body 2 is irradiated with the detection light, the detection light reflected by the object passes through a space above the top face 2A of the body 2 and enters the light receiving surface 45. The optical sensor 40 can detect objects ahead of the body 2 without being obstructed by the body 2.

The light emitter 42 and the light receiver 43 are fixed to the rotating body 41. The rotating body 41 rotates about the rotation axis BX with the light emitter 42 and the light receiver 43 held therein. The light emitter 42 emits detection light while the rotating body 41 is rotating. The light receiver 43 receives the detection light while the rotating body 41 is rotating. When the light emitter 42 emits detection light while the rotating body 41 is rotating, the detection light irradiates objects around the body 2. Based on detection light received by the light receiver 43, the controller 100 can detect objects around the body 2.

The rotating body 41 is rotatably supported by the support member 46. The rotating body 41 rotates about the rotation axis BX while being supported by the support member 46. Received light data of the light receiver 43 is transmitted to the controller 100 via a signal line 47.

The cover member 50 rotates about the rotation axis CX. The rotation axis CX of the cover member 50 is perpendicular to the top face 2A of the body 2. The rotation axis CX extends in the up-down direction. The rotation axis BX of the rotating body 41 and the rotation axis CX of the cover member 50 are parallel to each other. In the embodiment, the rotation axis BX of the rotating body 41 and the rotation axis CX of the cover member 50 coincide with each other.

The rotation sensor 60 detects rotation of the cover member 50. The cover member 50 rotates when coming into contact with an object. Rotation of the cover member 50 is detected, whereby the contact between the cover member 50 and an object is detected. The rotation sensor 60 is arranged in the internal space of the housing 11. The rotation sensor 60 is a non-contact sensor that detects rotation of the cover member 50 in a non-contact manner.

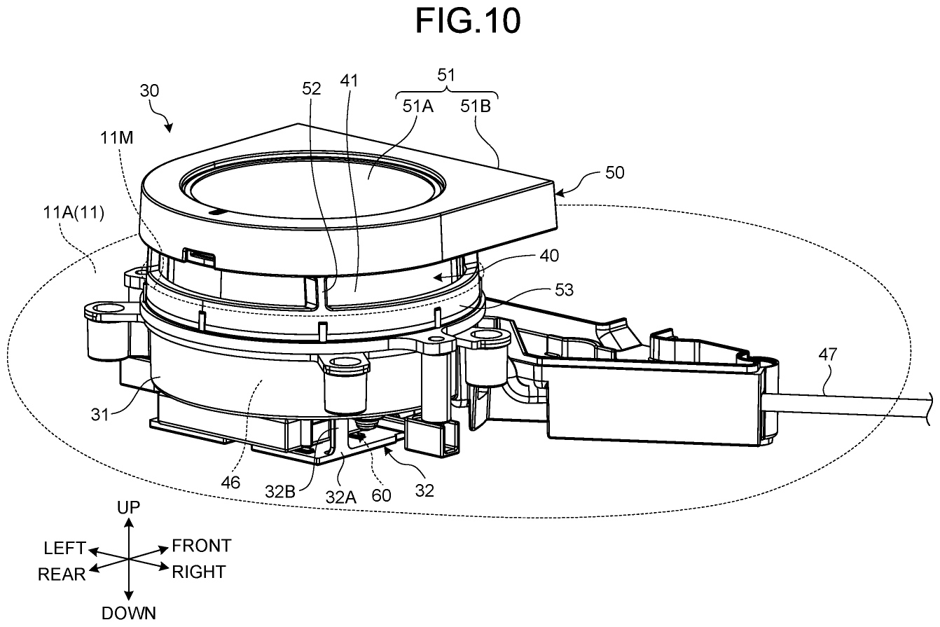

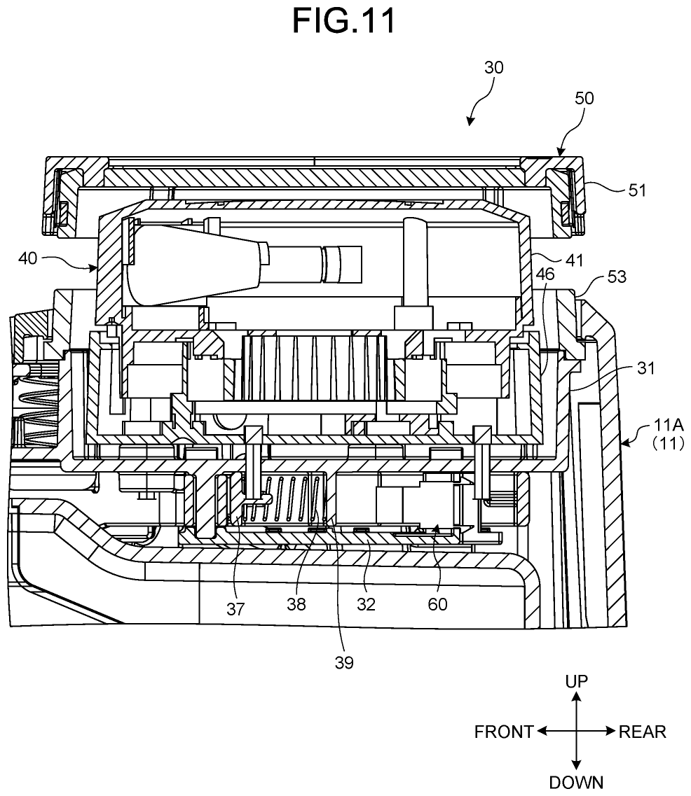

FIG. 10 is a perspective view of the detecting device 30 according to the embodiment. FIG. 11 is a sectional view of the detecting device 30 according to the embodiment. As illustrated in FIG. 10 and FIG. 11, at least a part of the detecting device 30 is arranged in the internal space of the housing 11. As illustrated in FIG. 6 and FIG. 10, an opening 11M is formed in a part of the upper housing 11A. At least a part of the detecting device 30 is arranged inside the opening 11M.

As illustrated in FIG. 10 and FIG. 11, the detecting device 30 includes a holder member 31 that holds the optical sensor 40, and a support member 32 arranged below the holder member 31. At least a part of the holder member 31 is arranged below the optical sensor 40. The holder member 31 holds the optical sensor 40 from below. The holder member 31 holds the support member 46 of the optical sensor 40 from below.

The cover member 50 is rotatably supported by the holder member 31.

The rotation sensor 60 is arranged below the holder member 31. The rotation sensor 60 is supported by the support member 32.

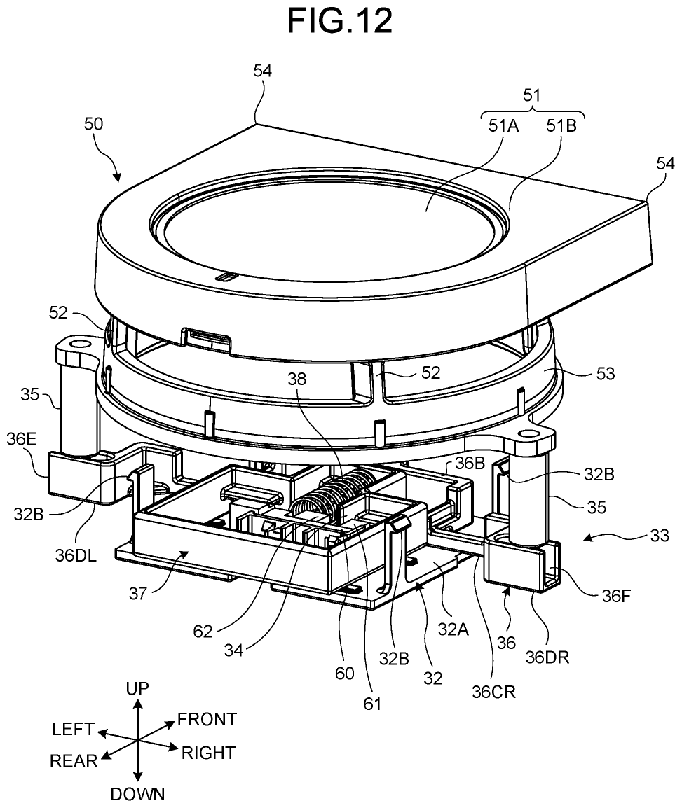

FIG. 12 is a perspective view of a part of the detecting device 30 according to the embodiment. FIG. 12 corresponds to the view of FIG. 10 but with the optical sensor 40 and the holder member 31 removed.

As illustrated in FIG. 10, FIG. 11, and FIG. 12, the cover member 50 includes an upper plate part 51 arranged above the optical sensor 40, the leg parts 52 arranged around the optical sensor 40 and supporting the upper plate 51, and a cylindrical part 53 supporting the leg parts 52.

The upper plate part 51 protects the rotating body 41. In a plane perpendicular to the rotation axis CX, the upper plate part 51 has a larger outer shape than the outer shape of the rotating body 41.

In the embodiment, the upper plate part 51 includes a first upper plate part 51A supported by the leg parts 52, and a second upper plate part 51B that is removable from the first upper plate part 51A. The second upper plate part 51B includes corner parts 54.

The second upper plate part 51B is made of synthetic resin. The second upper plate part 51B may be made of rubber.

The first upper plate part 51A and the second upper plate part 51B may be integral with each other.

The leg parts 52 are arranged below the upper plate part 51. The leg parts 52 are provided at intervals in the circumference of the rotating body 41. In the embodiment, four such leg parts 52 in total are provided around the rotating body 41. The detection light of the optical sensor 40 can pass through the openings defined between the adjacent leg parts 52.

The cylindrical part 53 is arranged below the leg parts 52. At least a part of the cylindrical part 53 is arranged around the rotating body 41. In a plane perpendicular to the rotation axis CX, the cylindrical part 53 has a circular shape. The diameter of the cylindrical part 53 is larger than the diameter of the rotating body 41. The cylindrical part 53 is rotatably supported by the holder member 31.

The support member 32 is connected to the holder member 31. The support member 32 includes a plate part 32A and hook parts 32B that are hung on the holder member 31. By hanging the hook parts 32B on at least parts of the holder member 31, the support member 32 is connected to the holder member 31.

The detecting device 30 includes a link mechanism 33 supported by the support member 32 and connected to the cover member 50, and a detection member 34 that moves by the operation of the link mechanism 33.

In the embodiment, the link mechanism 33 converts a rotational motion of the cover member 50 into a linear motion of the detection member 34. In the embodiment, when the cover member 50 rotates about the rotation axis CX, the detection member 34 moves in the frontward or rearward direction.

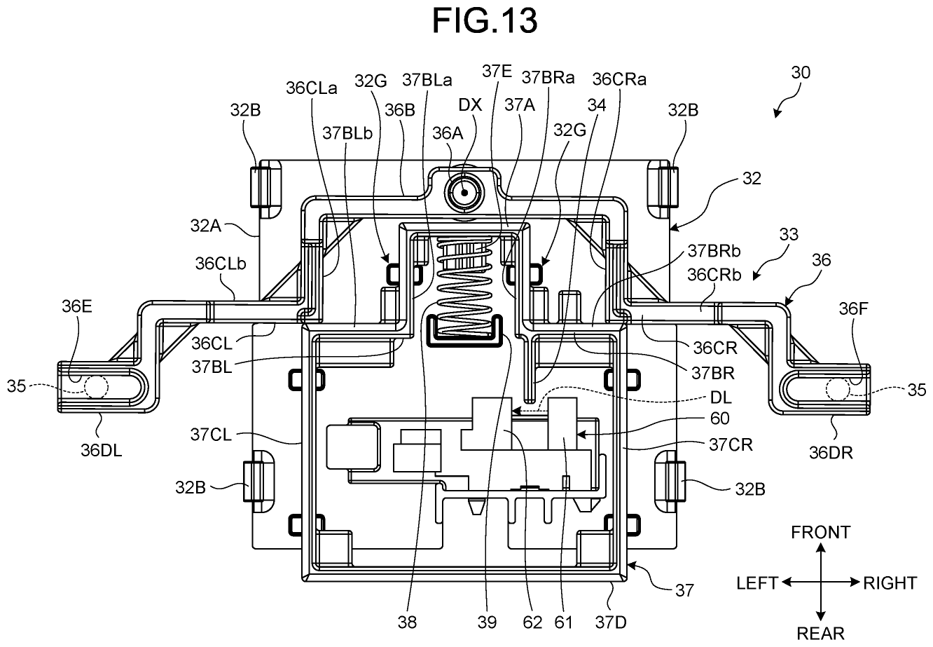

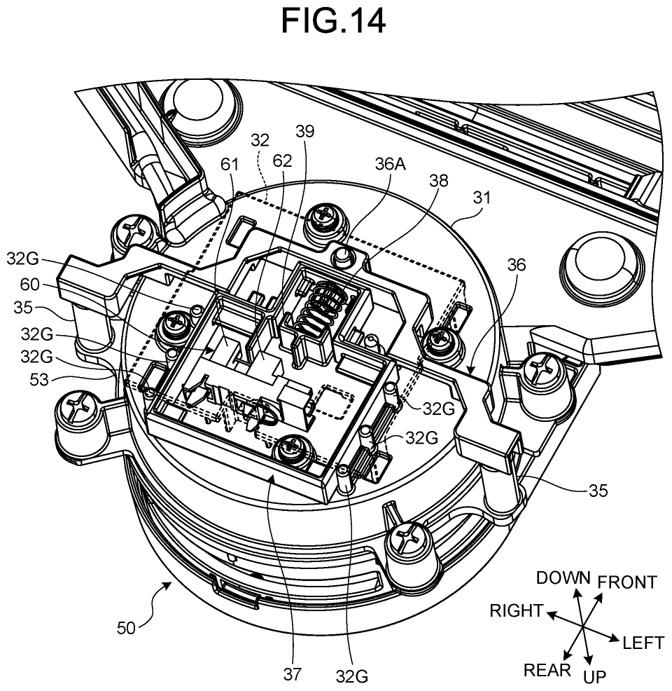

FIG. 13 is a plan view of the detecting device 30 according to the embodiment. FIG. 14 is a perspective bottom view of a part of the detecting device according to the embodiment. As illustrated in FIG. 12, FIG. 13, and FIG. 14, the link mechanism 33 includes pin members 35 extending downward from the cover member 50, a lever member 36 that tilts about a tilting axis DX while making contact with the pin members 35, and a moving member 37 that moves straight rearward upon making contact with the lever member 36.

The link mechanism 33 includes an elastic member 38 that generates elastic force that causes the moving member 37 to move frontward.

The pin members 35 extend downward from the cylindrical part 53 of the cover member 50. The pin members 35 are integral with the cylindrical part 53. When the cover member 50 rotates about the rotation axis CX, the pin members 35 rotate around the rotation axis CX. In the embodiment, a pair of such pin members 35 is provided. One of the pin members 35 is arranged to the left of the rotation axis CX. The other pin member 35 is arranged to the right of the rotation axis CX.

The lever member 36 tilts about the tilting axis DX. The tilting axis DX extends in the up-down direction. The lever member 36 tilts in a plane perpendicular to the tilting axis DX.

The lever member 36 includes a body part 36B supported by a plate part 32A via a pivot 36A, an arm part 36CL connected to the left end of the body part 36B, an arm part 36CR connected to the right end of the body part 36B, a holding part 36DL connected to the arm part 36CL, and a holding part 36DR connected to the arm part 36CR.

The body part 36B extends in the left-right direction. The pivot 36A connects the center of the body part 36B to the plate part 32A. The pivot 36A causes the body part 36B to tilt about the tilting axis DX.

The arm part 36CL includes a first arm part 36CLa extending rearward from the left end of the body part 36B, and a second arm part 36CLb extending leftward from the rear end of the first arm part 36CLa.

The arm part 36CR includes a first arm part 36CRa extending rearward from the right end of the body part 36B, and a second arm part 36CRb extending rightward from the rear end of the first arm part 36CRa.

The holding part 36DL includes a guide groove 36E into which the lower end of one of the pin members 35 is inserted. The holding part 36DR includes a guide groove 36F into which the lower end of the other pin member 35 is inserted.

The moving member 37 is supported by the plate part 32A so as to be movable in the frontward and rearward directions. The moving member 37 is guided in the frontward and rearward directions by guide parts 32G. As illustrated in FIG. 14, the guide parts 32G are provided on the holder member 31. The guide parts 32G protrude downward from the lower surface of the holder member 31.

The moving member 37 includes a body part 37A extending in the left-right direction, an arm part 37BL connected to the left end of the body part 37A, an arm part 37BR connected to the right end of the body part 37A, a straight part 37CL extending rearward from the left end of the arm part 37BL, a straight part 37CR extending rearward from the right end of the arm part 37BR, and a connection part 37D connecting the rear end of the straight part 37CL and the rear end of the straight part 37CR.

The arm part 37BL includes a first arm part 37BLa extending rearward from the left end of the body part 37A, and a second arm part 37BLb extending leftward from the rear end of the first arm part 37BLa. The front end of the straight part 37CL is connected to the left end of the second arm part 37BLb.

The arm part 37BR includes a first arm part 37BRa extending rearward from the right end of the body part 37A, and a second arm part 37BRb extending rightward from the rear end of the first arm part 37BRa. The front end of the straight part 37CR is connected to the right end of the second arm part 37BRb.

The connection part 37D extends in the left-right direction.

The detection member 34 is provided on the moving member 37. The detection member 34 extends rearward from the second arm part 37BRb. In the embodiment, the detection member 34 is integral with the moving member 37.

When the cover member 50 rotates, the detection member 34 moves in the frontward or rearward direction by the operation of the link mechanism 33.

The elastic member 38 is a coil spring. The front end of the elastic member 38 is supported by the support part 37E provided on the body part 37A. The rear end of the elastic member 38 is supported by a support part 39. As illustrated in FIG. 14, the support part 39 is provided on the holder member 31. The support part 39 protrudes downward from the lower surface of the holder member 31.

The rotation sensor 60 is supported by the support member 32. The rotation sensor 60 detects the detection member 34 in a non-contact manner. The rotation sensor 60 includes an emission part 61 that emits detection light DL, and a light receiving part 62 that can receive the detection light DL emitted from the emission part 61. The rotation sensor 60 detects the detection member 34 by emitting detection light DL from the emission part 61 to the movement range of the detection member 34.

FIG. 13 illustrates the initial state of the cover member 50 in which the cover member 50 is not rotated. The initial state of the cover member 50 includes a state in which no object is in contact with the cover member 50. In the initial state of the cover member 50, the detection member 34 is positioned outside the light path of the detection light DL of the rotation sensor 60. The detection light DL emitted from the emission part 61 is received by the light receiving part 62.

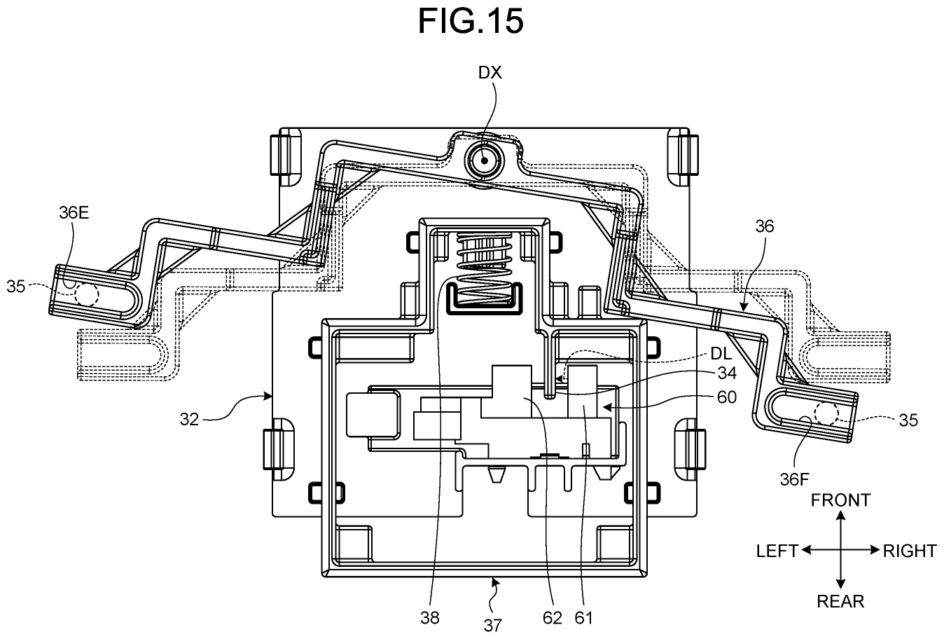

FIG. 15 is a view illustrating the operation of the detecting device 30 according to the embodiment. As illustrated in FIG. 15, when the cover member 50 rotates, the pin members 35 revolve about the rotation axis CX. The lower end of one of the pin members 35 is positioned in the guide groove 36E of the lever member 36. The lower end of the other pin member 35 is positioned in the guide groove 36F of the lever member 36. Therefore, when the pin members 35 revolve about the rotation axis CX, the lever member 36 tilts about the tilting axis DX due to the revolution of the pin members 35.

When the lever member 36 tilts, at least a part of the lever member 36 makes contact with the moving member 37. When the lever member 36 is further tilted with at least a part of the lever member 36 making contact with the moving member 37, the moving member 37 moves rearward as illustrated in FIG. 15. The moving member 37 moves straight rearward while being guided by the guide parts 32G illustrated in FIG. 14.

When the moving member 37 moves rearward, the detection member 34 also moves rearward. The detection member 34 is positioned in the optical path of the detection light DL emitted from the emission part 61 of the rotation sensor 60. The detection member 34 positioned in the optical path of the detection light DL makes it impossible for the light receiving part 62 to receive the detection light DL. As a result, the rotation sensor 60 can detect that the cover member 50 has rotated.

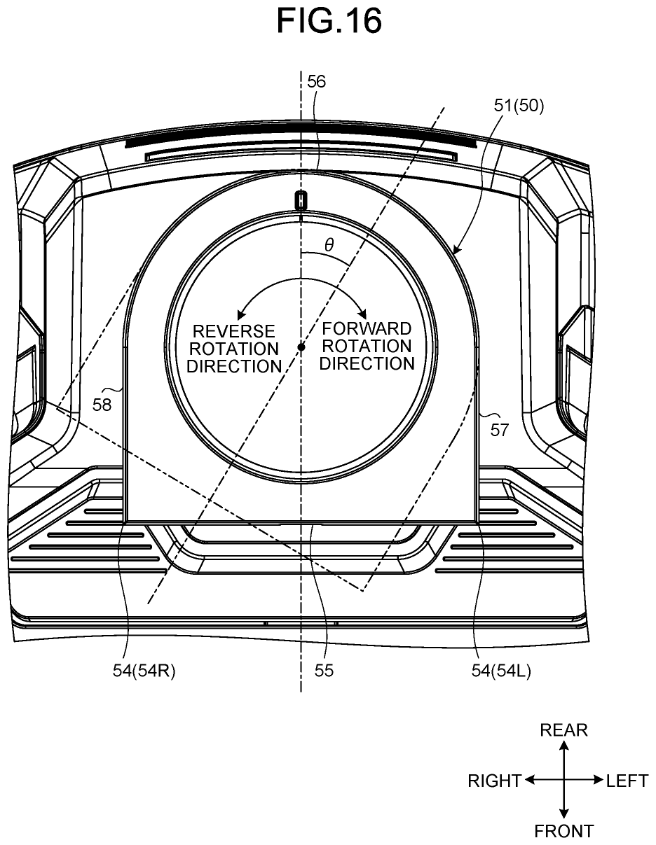

FIG. 16 is a plan view of the cover member 50 according to the present embodiment. As illustrated in FIG. 16, the upper plate part 51 of the cover member 50 includes a front side part 55 extending in the leftward and rightward directions, an arc part 56 arranged behind the front side part 55, a left side part 57 extending in the front-rear direction, a right side part 58 extending in the front-rear direction, and the corner parts 54.

The front side part 55 is linear. The arc part 56 projects rearward. The left side part 57 is linear. The left side part 57 connects the left end of the front side part 55 to the left front end of the arc part 56. The right side part 58 is linear. The right side part 58 connects the right end of the front side part 55 to the right front end of the arc part 56.

Two such corner parts 54 in total are provided. The corner parts 54 include a corner part 54L provided at the boundary between the front side part 55 and the left side part 57, and a corner part 54R provided at the boundary between the front side part 55 and the right side part 58.

The cover member 50 rotates in a specified rotation range. The cover member 50 can rotate about the rotation axis CX from the initial state to a specified rotation angle θ in each of a forward rotation direction and a reverse rotation direction. The rotation angle θ of the cover member 50 is 90 degrees or less. In other words, when the rotation angle θ of the cover member 50 in the initial state in which the cover member 50 is not rotated is set to 0 degrees, the cover member 50 can rotate from the initial state up to 90 degrees in each of the forward rotation direction and the reverse rotation direction. The rotation angle θ of the cover member 50 from the initial state may be determined in the range of 5 to 15 degrees. In the embodiment, the cover member 50 can rotate up to 10 degrees from the initial state in the forward rotation direction and up to 10 degrees from the initial state in the reverse rotation direction.

Operation

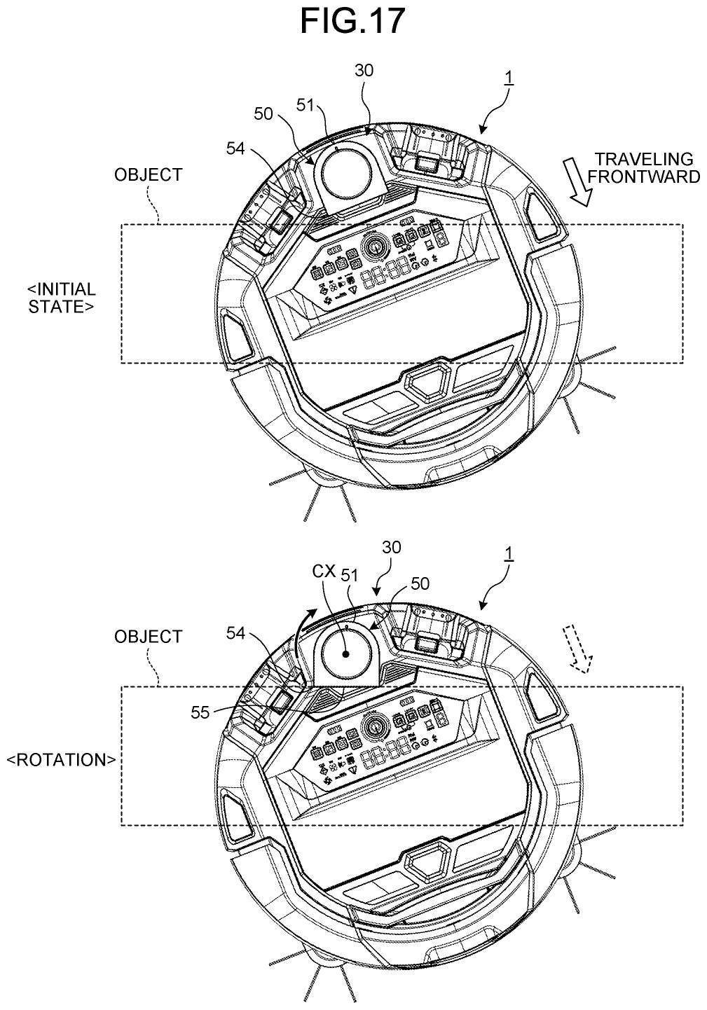

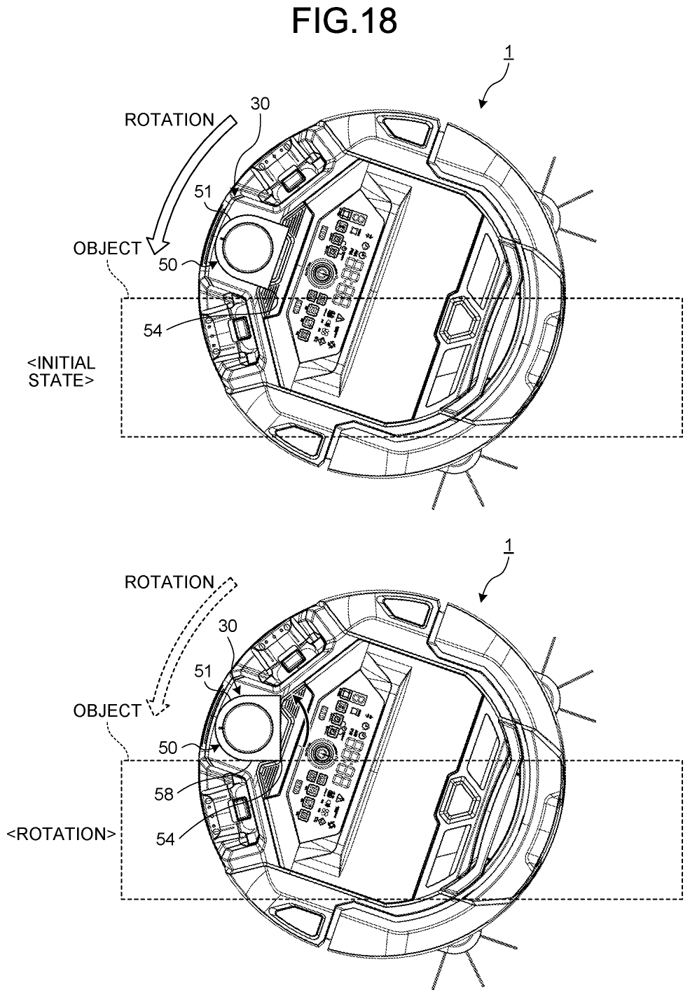

Next, the operation of the robot dust collector 1 according to the embodiment will be described. FIG. 17 and FIG. 18 are views each illustrating an operation of the robot dust collector 1 according to the embodiment. The robot dust collector 1 collects dust while autonomously traveling on the cleaning target floor FL by the operation of the traveling device 12. When no object is in contact with the cover member 50, the cover member 50 is in the initial state thereof.

As illustrated in FIG. 17, when the robot dust collector 1 collects dust while traveling frontward, an object may exist ahead of the robot dust collector 1. As illustrated in FIG. 18, when the robot dust collector 1 collects dust while rotating, an object may exist ahead of the robot dust collector 1 in the direction of rotation thereof.

When an object is above the top face 2A of the body 2 and below the top face of the cover member 50, at least a part of the cover member 50 may come into contact with the object, as illustrated in each of FIG. 17 and FIG. 18.

In the embodiment, the cover member 50 is rotatable about the rotation axis CX. As illustrated in each of FIG. 17 and FIG. 18, when the cover member 50 comes into contact with an object, the cover member 50 rotates.

As illustrated in FIG. 17, when one of the corner parts 54 of the cover member 50 comes into contact with an object when the robot dust collector 1 is traveling frontward, the cover member 50 rotates so as to change the state in which the corner part 54 comes into contact with the object to the state in which the front side part 55 comes into contact with the object. As illustrated in FIG. 18, when an object comes into contact with the corner part 54 of the cover member 50 when the robot dust collector 1 is rotating, the cover member 50 rotates so as to change the state in which the corner part 54 comes into contact with the object to the state in which the right side part 58 comes into contact with the object.

The rotation sensor 60 detects rotation of the cover member 50. Detection data of the rotation sensor 60 is output to the controller 100. Based on the detection data of the rotation sensor 60, the controller 100 can detect that the detecting device 30 is in contact with an object.

When rotation of the cover member 50 is detected while the traveling device 12 is autonomously traveling, the controller 100 changes traveling conditions for the traveling device 12. When contact between the detecting device 30 and an object is detected, the controller 100 changes traveling conditions for the traveling device 12 so that the detecting device 30 can be separated from the object. In the example illustrated in FIG. 17, the controller 100 moves the robot dust collector 1 rearward so that the detecting device 30 of the robot dust collector 1 and the object can be separated from each other. In the example illustrated in FIG. 18, the controller 100 causes the robot dust collector 1 to rotate rearward in a rotation direction so that the detecting device 30 of the robot dust collector 1 and the object can be separated from each other.

Effects

As described above, according to the embodiment, the cover member 50 of the detecting device 30 rotates about the rotation axis CX when the detecting device 30 comes into contact with an object while the robot dust collector 1 is traveling. The rotation of the cover member 50 is detected by the rotation sensor 60. Upon detection of the rotation of the cover member 50, the contact between the detecting device 30 and the object is detected.

When the robot dust collector 1 includes the detecting device 30 that detects objects in the vicinity, repeated contact between the detecting device 30 and objects may deteriorate the detecting device 30. According to the embodiment, contact between the detecting device 30 and objects is detected. Thus, measures can be taken to prevent the detecting device 30 from repeatedly coming into contact with objects.

The rotation sensor 60 detects rotation of the cover member 50 in a non-contact manner. Non-contact sensors are less susceptible to degradation than contact sensors. As a result, the life of the rotation sensor 60 is prevented from being shortened.

The rotation sensor 60 is arranged below the holder member 31. The rotation sensor 60 is protected by the holder member 31. As a result, deterioration of the rotation sensor 60 is prevented.

The rotation sensor 60 is supported by the support member 32 arranged below the holder member 31. As a result, the rotation sensor 60 can correctly detect rotation of the cover member 50.

The link mechanism 33 is connected to the cover member 50. When the cover member 50 rotates, the detection member 34 moves by the operation of the link mechanism 33. The rotation sensor 60 can correctly detect the rotation of the cover member 50 by detecting the movement of the detection member 34.

The link mechanism 33 converts a rotational motion of the cover member 50 into a linear motion of the detection member 34. The rotation sensor 60 can correctly detect the rotational motion of the cover member 50 by detecting a linear motion of the detection member 34.

The link mechanism 33 includes the pin members 35 extending downward from the cover member 50, the lever member 36 that tilts about the tilting axis DX while making contact with the pin members 35, and the moving member 37 that moves straight rearward upon making contact with the lever member 36. The detection member 34 is provided on the moving member 37. Thus, the detection member 34 can make a linear motion in conjunction with a rotational motion of the cover member 50.

The link mechanism 33 includes the elastic member 38 that generates elastic force to move the moving member 37 in the frontward direction. When the cover member 50 comes into contact with an object, the detection member 34 moves rearward from the initial position thereof by the operation of the link mechanism 33. When the cover member 50 comes out of contact with the object, the detection member 34 can return to the initial position by the elastic force of the elastic member 38.

The rotation sensor 60 is an optical sensor that detects the detection member 34 by emitting the detection light DL into the movement range of the member 34. Therefore, the rotation sensor 60 can detect movement of the detection member 34 in a non-contact manner with high accuracy.

The cover member 50 is rotatably supported by the holder member 31 that holds the optical sensor 40. Thus, the number of parts of the detecting device 30 can be reduced.

The cover member 50 includes: the upper plate part 51 arranged above the optical sensor 40; the leg parts 52 arranged around the optical sensor 40 and supporting the top plate part 51; and a cylindrical part 53 supporting the leg parts 52. The cylindrical part 53 is rotatably supported by the holder member 31. The upper plate part 51 and the leg parts 52 protect the optical sensor 40. The detection light emitted from the light emitter 42 of the optical sensor 40 irradiates objects around the robot dust collector 1 through the openings between the adjacent leg parts 52. The detection light reflected by the object can enter the light receiver 43 of the optical sensor 40 through the openings between the adjacent leg parts 52.

The upper plate part 51 includes the corner parts 54. When the corner part 54 comes into contact with an object, the cover member 50 can rotate.

The rotation sensor 60 is arranged in the internal space of the housing 11. This ensures that the rotation sensor 60 is adequately protected by the housing 11.

The cover member 50 can rotate from the initial state to the specified rotation angle θ in each of the forward rotation direction and the reverse rotation direction. Therefore, as illustrated in FIG. 17, when an object exists ahead of the robot dust collector 1 on the right while the robot dust collector 1 is traveling frontward, the cover member 50 can rotate in the forward rotation direction upon making contact with the object. When an object exists ahead of the robot dust collector 1 on the left while the robot dust collector 1 is traveling frontward, the cover member 50 can rotate in the reverse rotation direction upon making contact with the object. As illustrated in FIG. 18, while the robot dust collector 1 is rotating in a first rotation direction, when an object exists ahead of the robot dust collector 1 in the rotation direction, the cover member 50 can rotate in the reverse rotation direction upon making contact with the object. While the robot dust collector 1 is rotating in a second rotation direction opposite to the first rotation direction, when an object exists ahead of the robot dust collector 1 in the rotation direction, the cover member 50 can rotate in the forward rotation direction upon making contact with the object. In addition, the rotation angle θ of the cover member 50 from the initial state is set to 90 degrees or less, whereby complexity of structure of the detecting device 30 is suppressed.

When rotation of the cover member 50 is detected while the traveling device 12 is traveling, the controller 100 changes traveling conditions for the traveling device 12. This prevents repeated contact between the detecting device 30 and objects.

### REFERENCE SIGNS LIST

1 ROBOT DUST COLLECTOR
2 BODY
2A TOP FACE
2B BOTTOM FACE
2C SIDE FACE
3 BUMPER
4 BATTERY MOUNTING PART
5 SUCTION FAN
6 SUCTION MOTOR
7 CASTER
8 ROLLER
9 WHEEL
10 WHEEL MOTOR
11 HOUSING
11A UPPER HOUSING
11B LOWER HOUSING
11C COVER PLATE
11D BOTTOM PLATE
11M OPENING
12 TRAVELING DEVICE
13 MAIN BRUSH
14 MAIN BRUSH MOTOR
15 SIDE BRUSH
15B BRUSH
15D DISC MEMBER
16 SIDE BRUSH MOTOR
17 HANDLE
18 SUCTION INLET
19 OBSTACLE SENSOR
20 INTERFACE DEVICE
20A POWER BUTTON
20B REMAINING POWER INDICATOR
30 DETECTING DEVICE
31 HOLDER MEMBER
32 SUPPORT MEMBER
32A PLATE PART
32B HOOK PART
32G GUIDE PART
33 LINK MECHANISM
34 DETECTION MEMBER
35 PIN MEMBER
36 LEVER MEMBER
36A PIVOT
36B BODY PART
36CL ARM PART
36CLa FIRST ARM PART
36CLb SECOND ARM PART
36CR ARM PART
36CRa FIRST ARM PART
36CRb SECOND ARM PART
36DL HOLDING PART
36DR HOLDING PART
36E GUIDE GROOVE
36F GUIDE GROOVE
37 MOVING MEMBER
37A BODY PART
37BL ARM PART
37BLa FIRST ARM PART
37BLb SECOND ARM PART
37BR ARM PART
37BRa FIRST ARM PART
37BRb SECOND ARM PART
37CL STRAIGHT PART
37CR STRAIGHT PART
37D CONNECTION PART
37E SUPPORT PART
38 ELASTIC MEMBER
39 SUPPORT PART
40 OPTICAL SENSOR
41 ROTATING BODY
41A TOP PLATE PART
41B SIDE PLATE PART
41C HOLDING PLATE PART
41D FIRST OPENING
41E SECOND OPENING
42 LIGHT EMITTER
43 LIGHT RECEIVER
44 LIGHT EMITTING SURFACE
45 LIGHT RECEIVING SURFACE
46 SUPPORT MEMBER
47 SIGNAL LINE
50 COVER MEMBER
51 UPPER PLATE PART
51A FIRST UPPER PLATE PART
51B SECOND UPPER PLATE PART
52 LEG PART
53 CYLINDRICAL PART
54 CORNER PART
54L CORNER PART
54R CORNER PART
55 FRONT SIDE PART
56 ARC PART
57 LEFT SIDE PART
58 RIGHT SIDE PART
60 ROTATION SENSOR
61 EMISSION PART
62 LIGHT RECEIVING PART
100 CONTROLLER
AX ROTATION AXIS
BX ROTATION AXIS (SECOND ROTATION AXIS)
CX ROTATION AXIS (FIRST ROTATION AXIS)
DL DETECTION LIGHT
DX TILTING AXIS
BT BATTERY
FL CLEANING TARGET FLOOR

1. A detecting device including an optical sensor, the detecting device comprising:
a cover member that is arranged at least partially around the optical sensor and is rotatable about a first rotation axis; and
a rotation sensor configured to detect rotation of the cover member.

2. The detecting device according to claim 1, wherein the rotation sensor detects the rotation of the cover member in a non-contact manner.

3. The detecting device according to claim 1, comprising a holder member that holds the optical sensor from below, wherein
the rotation sensor is arranged below the holder member.

4. The detecting device according to claim 3, comprising a support member arranged below the holder member, wherein
the rotation sensor is supported by the support member.

5. The detecting device according to claim 4, comprising:
a link mechanism supported by the support member and connected to the cover member; and
a detection member configured to move by operation of the link mechanism, wherein
the rotation sensor detects the detection member.

6. The detecting device according to claim 5, wherein the link mechanism converts a rotational motion of the cover member into a linear motion of the detection member.

7. The detecting device according to claim 6, wherein
the link mechanism includes
a pin member extending downward from the cover member,
a lever member configured to tilt about a tilting axis while making contact with the pin member, and
a moving member configured to move straight in a first direction upon making contact with the lever member, and
the detection member is provided on the moving member.

8. The detecting device according to claim 7, wherein the link mechanism includes an elastic member configured to generate elastic force to move the moving member in a second direction opposite to the first direction.

9. The detecting device according to claim 5, wherein the rotation sensor detects the detection member by emitting detection light to a movement range of the detection member.

10. The detecting device according to claim 3, wherein the cover member is rotatably supported by the holder member.

11. The detecting device according to claim 10, wherein
the cover member includes
an upper plate part arranged above the optical sensor,
a leg part arranged around the optical sensor and supporting the upper plate part, and
a cylindrical part supporting the leg part, and
the cylindrical part is rotatably supported by the holder member.

12. The detecting device according to claim 11, wherein the upper plate part includes a corner part.

13. The detecting device according to claim 1, wherein
the optical sensor includes
a rotating body configured to rotate about a second rotation axis,
a light emitter provided on the rotating body, and
a light receiver provided on the rotating body, and
the cover member is arranged at least partially around the rotating body.

14. The detecting device according to claim 13, wherein the first rotation axis and the second rotation axis coincide with each other.

15. The detecting device according to claim 1, wherein
the cover member is rotatable from an initial state of the cover member to a specified rotation angle in each of a forward rotation direction and a reverse rotation direction, and
the specified rotation angle is 90 degrees or less.

16. A robot dust collector comprising:
a battery mounting part on which a general-purpose battery is mounted; and
the detecting device according to claim 1.

17. The robot dust collector according to claim 16, comprising a housing having a suction inlet in a bottom face of the housing, wherein
a light emitter and a light receiver of the optical sensor are arranged above a top face of the housing.

18. The robot dust collector according to claim 17, wherein the rotation sensor is arranged in an internal space of the housing.

19. The robot dust collector according to claim 16, comprising:
a traveling device; and
a controller, wherein
when the rotation of the cover member is detected while the traveling device is traveling, the controller changes a traveling condition for the traveling device.
